(19) United States
(12) Patent Application Publication
(10) Pub. No.: US 2024/0304786 A1
(43) Pub. Date: Sep. 12, 2024

(54) SECONDARY BATTERY AND METHOD FOR MANUFACTURING SECONDARY BATTERY

(71) Applicant: Prime Planet Energy & Solutions, Inc., Tokyo (JP)

(72) Inventor: Naoto ONODERA, Kobe-shi (JP)

(21) Appl. No.: 18/587,953

(22) Filed: Feb. 27, 2024

(30) Foreign Application Priority Data
Mar. 10, 2023 (JP) 2023-037930
Jul. 28, 2023 (JP) 2023-122966

(51) Int. Cl. H01M 4/134; H01M 4/133; H01M 4/1393; H01M 4/1395; H01M 4/38; H01M 4/587; H01M 4/62; H01M 4/02

(52) U.S. Cl. CPC H01M 4/134; H01M 4/133; H01M 4/1393; H01M 4/1395; H01M 4/386; H01M 4/587; H01M 4/625; H01M 2004/021; H01M 2004/027

(57) ABSTRACT

The secondary battery disclosed herein is a secondary battery, including an electrode body having a positive electrode and a negative electrode, wherein the negative electrode includes a negative current collector, and a negative active material layer placed on the negative current collector. The negative active material layer includes graphite particles and Si-containing particles as negative active materials, and a carbon nanotube as a conductive material. The Si-containing particles is porous bodies containing Si nanoparticles with a network structure, and the carbon nanotube 68 is placed in at least several pores of the porous bodies. When the weight of the Si-containing particles is 100 wt %, the weight ratio X of the carbon nanotube to the Si-containing particles is 0.02 wt % or more and 4 wt % or less.

### CROSS REFERENCE TO RELATED APPLICATION

The present application claims priority based on Japanese Patent Application No. 2023-037930 filed on Mar. 10, 2023 and Japanese Patent Application No. 2023-122966 filed on Jul. 28, 2023, the entire contents of which are incorporated in the present specification by reference.

### BACKGROUND OF THE DISCLOSURE

### 1. Field

The present disclosure relates to a secondary battery and a method for manufacturing a secondary battery.

### 2. Background

Secondary batteries such as lithium ion secondary batteries have been suitably used for portable power supplies for, for example, personal computers and portable terminals, vehicle driving power supplies for, for example, battery electric vehicles (BEV), hybrid electric vehicles (HEV) and plug in hybrid electric vehicles (PHEV), and the like. Negative electrodes used for the secondary batteries as described above commonly have a structure in which a negative active material layer including a negative active material is placed on a negative current collector.

In recent years, the use of a Si-based material as a negative active material has been considered for the purpose of obtaining secondary batteries with a high capacity, for example (e.g., Japanese Unexamined Patent Application Publication (Translation of PCT Application) No. 2018-534720, Japanese Unexamined Patent Application Publication No. 2021-38114 and WO2022/070895). Japanese Unexamined Patent Application Publication (Translation of PCT Application) No. 2018-534720 discloses a composite of a porous carbon material having micropores, mesopores and/or macropores and silicon. Japanese Unexamined Patent Application Publication No. 2021-38114 also discloses a silicon material, the precursor of which is amorphous silica generated from a plant raw material. WO2022/070895 discloses a negative electrode, including a negative active material including a Si-based material, a carbon nanotube with an outermost circumference of 5 nm or less, and carboxymethyl cellulose with a weight average molecular weight of 150000 or more and 450000 or less.

### SUMMARY

Si-based materials have a larger specific capacity than that of carbon materials such as graphite particles, and meanwhile conductive paths tend to be cut due to large expansion and contraction during charging and discharging. Because of this, when using the Si-based material, the initial characteristics (e.g., initial charge-discharge efficiency) of secondary batteries are easily reduced. Therefore, when using the Si-based material as a negative active material, enhancements of the initial characteristics of secondary batteries still have room for improvement.

The present disclosure has been made in view of the above points, and an object thereof is to provide a secondary battery, including a negative electrode including graphite particles and a Si-based material as negative active materials, which secondary battery has an excellent initial charge-discharge efficiency.

The secondary battery disclosed herein is a secondary battery, including an electrode body having a positive electrode and a negative electrode, wherein the negative electrode includes a negative current collector, and a negative active material layer placed on the negative current collector, and the negative active material layer includes graphite particles and Si-containing particles as negative active materials, and a carbon nanotube as a conductive material. The Si-containing particles are porous bodies containing Si nanoparticles with a network structure, and the carbon nanotube is placed in at least several pores of the porous bodies. When the weight of the Si-containing particles is 100 wt %, the weight ratio X of the carbon nanotube to the Si-containing particles is 0.02 wt % or more and 4 wt % or less.

According to such structure, because the Si-containing particles are porous bodies containing Si nanoparticles with a network structure, conductive paths are suitably formed. When the Si-containing particles have a plurality of pores and the carbon nanotube is suitably placed in the pores, conductive paths are also formed between the graphite particles and the Si-containing particles. Therefore, a secondary battery having high initial characteristics can be achieved.

### BRIEF DESCRIPTION OF THE DRAWINGS

FIG. 1 is a diagram schematically showing the inner structure of a secondary battery according to one embodiment;

FIG. 2 is a diagram schematically showing the structure of an electrode body according to one embodiment;

FIG. 3 is a diagram schematically showing a negative electrode according to one embodiment; and

FIG. 4 is a flowchart showing a method for manufacturing a secondary battery according to one embodiment.

### DETAILED DESCRIPTION OF THE PREFERRED EMBODIMENTS

Embodiments of the technique disclosed herein will now be described with reference to drawings. It should be noted that things other than matters particularly mentioned in the specification, which are necessary to implement the technique disclosed herein (for example, general structures and production processes for secondary batteries which do not characterize the technique disclosed herein) can be understood as design matters of those skilled in the art based on conventional techniques in the art. The technique disclosed herein can be implemented based on the contents disclosed in the specification and technical knowledge in the art. It should be noted that each diagram is schematically drawn, and dimensions (e.g., length, width and thickness) do not necessarily reflect actual dimensions. In the diagrams described below, the same sign is provided to members and sites having the same actions, and duplicate descriptions may be omitted or simplified. In addition, the expression of “A to B (A and B are optional values)” showing a range in the specification means “A or more and B or less.”

It should be noted that the “secondary battery” in the specification means a battery in which charging and discharging can be repeated by the movement of a charge carrier between positive and negative electrodes. In the specification the “lithium ion secondary battery” means a secondary battery, in which lithium ion is used as a charge carrier, and charging and discharging are achieved by the movement of the electric charge with lithium ion between positive and negative electrodes.

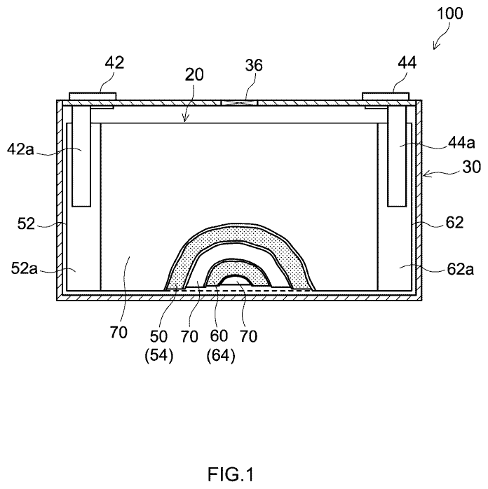

FIG. 1 is a diagram schematically showing the inner structure of a secondary battery 100 according to one embodiment. As shown in FIG. 1, the secondary battery 100 includes an electrode body 20 having a positive electrode 50 and negative electrode 60, an electrolyte solution (not shown), and a battery case 30 to hold the electrode body 20 and the electrolyte solution. The secondary battery 100 shown in FIG. 1 is a lithium ion secondary battery here. The negative electrode 60 disclosed herein is preferably used as a negative electrode for lithium ion secondary batteries.

The battery case 30 has a positive terminal 42 and a negative terminal 44 for external connection, and a thin-walled safety vent 36 set to, when the inner pressure of the battery case 30 is raised to a predetermined level or more, release the inner pressure. The battery case 30 also has an inlet to inject a nonaqueous electrolyte solution (not shown). The positive terminal 42 is electrically connected to a positive current collecting plate 42a. The negative terminal 44 is electrically connected to a negative current collecting plate 44a. As the material of the battery case 30, a metal material which is light and has good thermal conductivity such as aluminum is used.

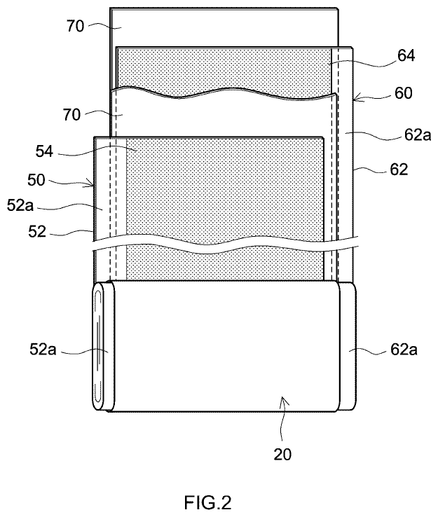

FIG. 2 is a diagram schematically showing the structure of the electrode body 20. The electrode body 20 here is a flat-shaped wound electrode body. As shown in FIG. 2, the electrode body 20 has a form in which a long sheet-shaped positive electrode 50 (hereinafter also referred to as “positive electrode sheet 50”) and a long sheet-shaped negative electrode 60 (hereinafter also referred to as “negative electrode sheet 60”) are laminated with two long separators 70 each between the electrodes, and they are wound in the longitudinal direction. The positive electrode sheet 50 has a structure in which a positive active material layer 54 is formed along the longitudinal direction on one surface or both surfaces of a long positive current collector 52 (both surfaces here). The negative electrode sheet 60 has a structure in which a negative active material layer 64 is formed along the longitudinal direction on one surface or both surfaces of a long negative current collector 62 (both surfaces here). As shown in FIG. 1 and FIG. 2, a positive current collector exposed part 52a (that is, a part in which the positive active material layer 54 is not formed and the positive current collector 52 is exposed), and a negative current collector exposed part 62a (that is, a part in which the negative active material layer 64 is not formed and the negative current collector 62 is exposed) are formed to project outward from both ends of the electrode body 20 in the winding axis direction (that is, the sheet width direction perpendicular the longitudinal direction). The positive current collecting plate 42a and the negative current collecting plate 44a are joined to the positive current collector exposed part 52a and the negative current collector exposed part 62a, respectively.

The positive current collector 52 forming the positive electrode sheet 50 is not particularly limited, and a known positive current collector used for lithium ion secondary batteries may be used. Examples thereof can include sheets or foil made of metal having favorable conductive properties (e.g., aluminum, nickel, titanium and stainless steel). The positive current collector 52 is preferably aluminum foil. The dimensions of the positive current collector 52 are not particularly limited, and may be appropriately determined depending on battery designs. When aluminum foil is used as the positive current collector 52, the thickness thereof is not particularly limited, and is, for example, 5 μm or more and 35 μm or less, and preferably 7 μm or more and 20 μm or less.

The positive active material layer 54 contains a positive active material. As the positive active material, a positive active material having known composition used for lithium ion secondary batteries may be used. As the positive active material, specifically, for example, lithium composite oxides, lithium transition metal phosphate compounds (e.g., lithium iron phosphate (LiFePO₄) and lithium manganese phosphate (LiMnPO₄)) and the like may be used. The crystal structure of the positive active material is not particularly limited, and may be a layer structure, a spinel structure, an olivine structure or the like.

The lithium composite oxide is preferably a lithium transition metal composite oxide including at least one of Ni, Co and Mn as a transition metal element, and specific examples thereof include lithium nickel composite oxides, lithium cobalt composite oxides, lithium manganese composite oxides, lithium nickel manganese composite oxides, lithium nickel cobalt manganese composite oxides, lithium nickel cobalt aluminum composite oxides, lithium iron nickel manganese composite oxides and the like. These positive active materials may be used individually or two or more of them may be used in combination. Among these, lithium nickel cobalt manganese composite oxides can be preferably used as the positive active material.

It should be noted that the “lithium nickel cobalt manganese composite oxides” in the specification is a term including oxides having Li, Ni, Co, Mn and O as constituent elements, and further encompassing oxides including one or two or more additional elements in addition to the above. Examples of such additional elements include transition metal elements and typical metal elements such as Mg, Ca, Al, Ti, V, Cr, Y, Zr, Nb, Mo, Hf, Ta, W, Na, Fe, Zn and Sn and the like. The additional elements may be also metalloid elements such as Y/Z, Si and P, and nonmetal elements such as S, F, Cl, Br and I. The same applies to the lithium nickel composite oxides, lithium cobalt composite oxides, lithium manganese composite oxides, lithium nickel manganese composite oxides, lithium nickel cobalt aluminum composite oxides, lithium iron nickel manganese composite oxides and the like.

The positive active material layer 54 may also include components other than the positive active material such as a conductive material and a binder. As the conductive material, for example, carbon black such as acetylene black (AB); carbon fibers such as vapor grown carbon fiber (VGCF) and carbon nanotube (CNT); other carbon materials (e.g., graphite) can be suitably used. As the binder, for example, polyvinylidene difluoride (PVdF) and the like can be used.

The amount of the conductive material is not particularly limited, and is preferably 0.1 wt % or more and 10 wt % or less, and more preferably 1 wt % or more and 5 wt % or less when the weight of the positive active material is 100 wt %. The amount of the binder is preferably 0.1 wt % or more and 10 wt % or less, and more preferably 1 wt % or more and 5 wt % or less when the weight of the positive active material is 100 wt %.

The thickness per surface of the positive active material layer 54 is not particularly limited, and is, for example, 20 μm or more, and preferably 50 μm or more. Meanwhile, the thickness is, for example, 300 μm or less, and preferably 200 μm or less.

As the separator 70, various microporous sheets which have been conventionally used can be used, and examples thereof can include a microporous resin sheet including a resin such as polyethylene (PE) or polypropylene (PP). Such microporous resin sheet may have a single layer structure or a multi-layer structure having two or more layers (e.g., a three layer structure in which a PP layer is laminated on both surfaces of a PE layer). The separator 70 may also include a heat resistance layer (HRL).

As the electrolyte, those which have conventionally used can be used, and a nonaqueous electrolyte solution containing a supporting salt in an organic solvent (nonaqueous solvent), for example, can be used. As the nonaqueous solvent, aprotic solvents such as carbonates, esters and ethers can be used. Among these, carbonates such as ethylene carbonate (EC), diethyl carbonate (DEC), dimethyl carbonate (DMC), ethylmethyl carbonate (EMC) and the like, for example, can be suitably adopted. Alternatively, fluorine-based solvents, e.g., fluorinated carbonates such as monofluoroethylene carbonate (MFEC), difluoroethylene carbonate (DFEC), monofluoromethyl difluoromethyl carbonate (F-DMC), trifluorodimethyl carbonate (TFDMC) and the like can be preferably used. Such nonaqueous solvents can be used individually or two or more of them can be used in appropriate combination. As the supporting salt, for example, a lithium salt such as LiPF₆, LiBF₄ or LiClO₄ can be suitably used. The concentration of the supporting salt is not particularly limited, and is preferably about 0.7 μmol/L or more and 1.3 μmol/L or less.

It should be noted that the nonaqueous electrolyte may include a component other than the above nonaqueous solvent and supporting salt as long as the effect of the present technique is not significantly lost, and can include various additives such as a gas generating agent, a film forming agent, a dispersant and a thickening agent.

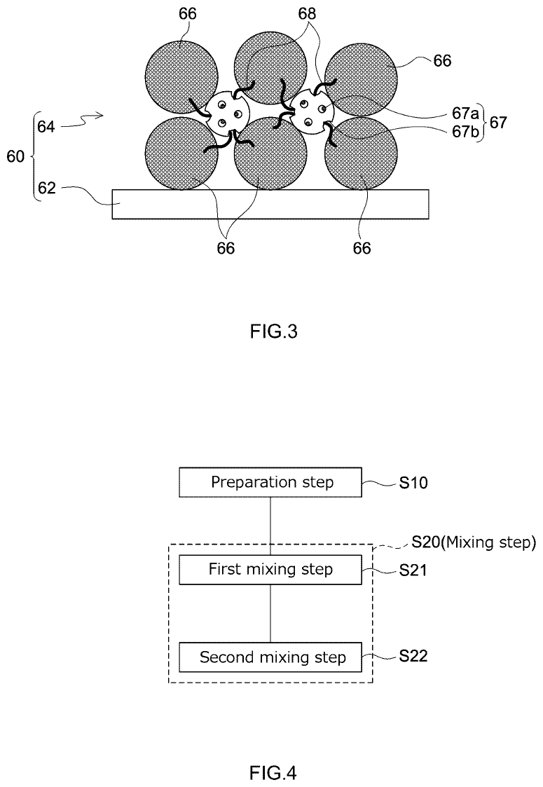

The negative electrode 60 in the secondary battery disclosed herein will now be described. FIG. 3 is a diagram schematically showing the negative electrode 60 in the secondary battery 100 disclosed herein. As shown in FIG. 3, the negative electrode 60 includes the negative current collector 62, and the negative active material layer 64 placed on the negative current collector 62. The negative current collector 62 is not particularly limited, and those which have been conventionally known may be used. Examples thereof include sheets or foil-shaped bodies made of metal such as copper, nickel, titanium or stainless steel. When copper foil is used as the negative current collector 62, the average thickness thereof is not particularly limited, and is, for example, 5 μm or more and 30 μm or less, preferably 5 μm or more and 20 μm or less, and more preferably 5 μm or more and 15 μm or less.

The negative active material layer 64 includes at least negative active materials. The negative active material layer 64 includes at least graphite particles 66 and Si-containing particles 67 as the negative active materials. Such Si-containing particles 67 are porous bodies containing Si nanoparticles 67a with a network structure. The Si-containing particles 67 have a plurality of pores 67b. A carbon nanotube 68 is placed in at least several pores 67b among the plurality of pores 67b. When the weight of the Si-containing particles 67 is 100 wt %, the weight ratio X of the carbon nanotube 68 to the Si-containing particles 67 is adjusted to 0.02 wt % or more and 4 wt % or less. According to such structure, the initial charge-discharge efficiency of the secondary battery 100 can be enhanced.

It is not intended to limit the technique disclosed herein, but the reason why such effect is obtained is presumed as follows. Because the Si-containing particles 67 are porous bodies containing the Si nanoparticles 67a with a network structure, conductive paths are suitably enhanced. Because the Si-containing particles 67 have a plurality of pores 67b, the carbon nanotube 68 as the conductive material is suitably placed around the Si-containing particles 67 to form favorable charging paths between the graphite particles 66 and the Si-containing particles 67. Because of this, the initial charge-discharge efficiency of the secondary battery 100 is enhanced. Even when expansion and contraction with charging and discharging are repeated, because an anchor effect is displayed, the carbon nanotube 68 is not easily separated from the plurality of pores 67b. Furthermore, because the Si nanoparticles 67a have a network structure, the expansion of the Si nanoparticles 67a can be suppressed, and damage of the Si nanoparticles 67a due to the expansion does not easily occur. Because of this, even when expansion and contraction with charging and discharging are repeated, conductive paths are not easily cut, and the cycle characteristics of the secondary battery 100 are enhanced.

As the graphite particles 66, for example, artificial graphite, natural graphite and the like are used. The graphite particles 66 may have an amorphous carbon coating layer on the surface thereof. The shape of the graphite particles 66 is not particularly limited, and may be an almost spherical shape. It should be noted that “the almost spherical shape” in the specification is a term encompassing spherical and rugby ball shapes, and, for example, means a shape with an average aspect ratio (in the smallest rectangle that is circumscribed about a particle, the ratio of the length in the long axis direction to the length in the short axis direction) of, for example, 1 to 2 (preferably 1 to 1.5).

The D₅₀ particle size of the graphite particles 66 is not particularly limited, and is, for example, preferably 5 μm or more and 30 μm or less, and more preferably 10 μm or more and m or less. It should be noted that “the D₅₀ particle size of the graphite particles” in the specification means a particle diameter corresponding to the cumulative 50% point from finer particles in the particle size distribution on a volume basis obtained by the particle size distribution measurement based on laser diffraction and light scattering.

The Si-containing particles 67 are porous bodies including the Si nanoparticles 67a with a network structure. The Si-containing particles 67 may include a component other than Si as long as the particles include Si. Examples of the Si-containing particles 67 include SiOx, Si—C composites, Si nanoparticles dispersed in porous Si particles, and the like. The porous body part of the Si-containing particles 67 may be formed, for example, using Si as a main component or using carbon (C) as a main component. As the Si-containing particles 67, for example, a Si—C composite including Si nanoparticles with a network structure and porous carbon particles is preferably adopted. Alternatively, as the Si-containing particles 67, Si particles including Si nanoparticles with a network structure and porous Si particles are preferably adopted. It should be noted that “A is formed using B as a main component” in the specification means that among components forming A, B is the largest component on a weight basis.

The Si-containing particles 67 are porous bodies having a plurality of pores 67b. The Si-containing particles 67 can have, for example, micropores, mesopores and macropores. The micropores, mesopores and macropores here mean pores with a diameter of 2 nm or less, pores with a diameter of above 2 nm and less than 50 nm, and pores with a diameter of 50 nm or more, respectively. When the pore size is too large, there is a risk that the cycle characteristics of the secondary battery 100 will be reduced due to the penetration of an electrolyte solution. From such viewpoint, the size of the pores 67b of the Si-containing particles 67 is preferably, for example, 1 nm or more and 300 nm or less, and may be also 1 nm or more and 250 nm or less. The Si-containing particles 67 can have, for example, a nanoporous structure having a nanosize porous structure.

The Si-containing particles 67 preferably include pores with a diameter of 100 nm or more and pores with a diameter of 10 nm or less, but the present disclosure is not particularly limited thereto. When the Si-containing particles 67 have pores with 100 nm or more, an anchor effect is easily displayed, and the carbon nanotube is suitably placed on the surface of the Si-containing particles 67. Because of this, the initial charge-discharge efficiency of the secondary battery 100 can be enhanced. Furthermore, even when the Si-containing particles 67 repeat expansion and contraction with charging and discharging, a conductive material is not easily separated by the anchor effect, and conductive paths are not easily cut. Therefore, the cycle characteristics of the secondary battery 100 can be enhanced. When the Si-containing particles 67 have pores with 10 nm or less, the penetration of the electrolyte solution and expansion and contraction with charging and discharging can be suitably suppressed. Because of this, the cycle characteristics of the secondary battery 100 can be enhanced.

The Si-containing particles 67 are more preferably adjusted so that the ratio of the log differential pore volume V₁₀ of the pores with a diameter of 10 nm to the log differential pore volume V₁₀₀ of the pores with a diameter of 100 nm (V₁₀/V₁₀₀) may be 1 or more. That is, the Si-containing particles 67 preferably have a nanoporous structure, which has more pores with a relatively smaller diameter (e.g., pores with a diameter of 10 nm) than pores with a relatively larger diameter (e.g., pores with a diameter of 100 nm). Because of this, both the initial charge-discharge efficiency and the cycle characteristics of the secondary battery 100 can be suitably obtained. The ratio of V₁₀ to V₁₀₀ (V₁₀/V₁₀₀) is preferably above 1, more preferably 1.2 or more, and may be also 1.5 or more. The ratio of V₁₀ to V₁₀₀ (V₁₀/V₁₀₀) is preferably, for example, 20 or less, and may be also 10 or less.

The log differential pore volume V₁₀₀ of the pores with a diameter of 100 nm, and the log differential pore volume V₁₀ of the pores with a diameter of 10 nm can be calculated based on BJH method using a specific surface area and pore size distribution analyzer. First, the Si-containing particles are heated and dried under vacuum to obtain a measurement sample. Next, the adsorption isotherm of the measurement sample is obtained using liquid nitrogen as a refrigerant and nitrogen gas (N₂ gas) as adsorption gas, and the obtained adsorption isotherm is analyzed by BJH method to obtain log differential pore volume distribution. From the log differential pore volume distribution, the log differential pore volume V₁₀₀ of the pores with a diameter of 100 nm, and the log differential pore volume V₁₀ of pores with a diameter of 10 nm can be obtained.

The Si-containing particles 67 have the Si nanoparticles 67a with a network structure. The Si nanoparticles 67a are nanosize Si particles (i.e., less than 1 μm). The Si nanoparticles 67a can exist on the surface of the porous bodies and/or inside the pores 67b of the porous bodies. The Si nanoparticles 67a are preferably 100 nm or less, and more preferably 50 nm or less. Because of this, the amount of expansion and contraction during charging and discharging per particle of the Si nanoparticles 67a can be reduced, and the particles are not easily broken even when expansion and contraction are repeated. The average particle diameter of the Si nanoparticles 67a is not particularly limited, and can be, for example, 5 nm or more. It should be noted that “the average particle diameter of the Si nanoparticles” in the specification can be obtained as follows. First, by FIB (focused ion beam) processing of the negative active material layer, a sample for scanning transmission electron microscope (STEM) observation is produced. After the elemental analysis of the sample by EDX elemental mapping, BF images (bright field images) and HAADF images (high angle annular dark field images) are taken. From the contrast and shapes obtained from the BF images and the HAADF images, the diameter of the Si nanoparticles can be obtained. The arithmetic mean of diameters of at least 10 Si nanoparticles is considered “the average particle diameter of the Si nanoparticles” here.

The Si nanoparticles 67a have a network structure. In such network structure, a plurality of voids are randomly or regularly formed. Because the Si nanoparticles 67a has a network structure, conductive paths are suitably enhanced. Because the Si nanoparticles 67a have a network structure, excessive expansion and contraction of the Si nanoparticles 67a with charging and discharging are also suppressed.

In the Si-containing particles 67, a plurality of pores 67b preferably exist around the Si nanoparticles 67a, but the present disclosure is not particularly limited thereto. In particular, many pores with a smaller diameter (e.g., pores with a diameter of 10 nm or less) preferably exist around the Si nanoparticles 67a. Because of this, the penetration of the electrolyte solution can be suitably suppressed while reducing expansion and contraction with charging and discharging.

The amount of oxygen in the Si-containing particles is not particularly limited, and is preferably, for example, 10 wt % or less when the total weight of the Si-containing particles is 100 wt %. Because of this, side reactions caused by an excessive amount of oxygen can be reduced, and the capacity and cycle characteristics of the secondary battery can be suitably enhanced. It should be noted that the amount of oxygen can be measured by hot melting in an inert gas using an oxygen analyzer.

The D₅₀ particle size of the Si-containing particles 67 is not particularly limited, and is preferably, for example, 1 μm or more and 15 μm or less, and more preferably 2 μm or more and 10 μm or less. It should be noted that “the D₅₀ particle size of the Si-containing particles” in the specification means a particle diameter corresponding to the cumulative 50% point from finer particles in the particle size distribution on a volume basis obtained by the particle size distribution measurement based on laser diffraction and light scattering.

The Si-containing particles 67 can be obtained, for example, by burning a Si-containing plant. That is, the Si-containing particles 67 are preferably derived from plants. Specifically, raw materials may be chaff from rice (rice plant), barley, wheat, rye and the like, and plants such as coconut husks, tea leaves, sugar cane, corn and the like. Among these, the Si-containing particles 67 are preferably derived from chaff as a raw material. In plants, silicic acid absorbed from soil is accumulated around cell walls. By burning this, porous bodies containing plant-derived Si nanoparticles 67a with a network structure can be obtained. However, the Si-containing particles 67 may be also prepared by preparing porous bodies formed using Si or C as a main component, and Si nanoparticles with a network structure, and introducing the Si nanoparticles into the porous bodies.

The negative active material layer 64 may include components other than the graphite particles 66 and the Si-containing particles (e.g., SiOx which does not have the structure as described above, and hard carbon) as negative active materials as long as the effect of the present technique is not significantly lost.

The amount of the Si-containing particles 67 is not particularly limited, and is preferably 10 wt % or more and 60 wt % or less, and more preferably 20 wt % or more and 40 wt % or less when the total weight of the negative active materials (the sum of the weight of the graphite particles 66, the weight of the Si-containing particles 67 and the weight of other components which can be included as the negative active materials) is 100 wt %. When the total weight of the negative active materials is 100 wt %, the amount of the graphite particles 66 is preferably 40 wt % or more and 90 wt % or less, and more preferably 60 wt % or more and 80 wt % or less. That is, the weight ratio of the weight of the graphite particles 66 and the weight of the Si-containing particles is preferably adjusted to 90:10 to 40:60, and may be adjusted to 80:20 to 60:40. When the weight of the Si-containing particles 67 is adjusted to the above range, both the initial charge-discharge efficiency and enhancements of cycle characteristics can be suitably obtained.

In the secondary battery 100 disclosed herein, the carbon nanotube (CNT) 68 is used as the conductive material. The carbon nanotube 68 is fibrous carbon with a structure in which graphene having a carbon hexagonal network is rolled into a tube. The carbon nanotube 68 has a high aspect ratio and excellent conductive properties. Because of this, the carbon nanotube 68 is easily entangled among the graphite particles 66 and the Si-containing particles 67, and conductive paths are suitably maintained. As described above, the Si-containing particles 67 have a plurality of pores 67b, and the carbon nanotube 68 is placed in the pores 67b, and thus even when expansion and contraction with charging and discharging are repeated, the carbon nanotube 68 is not easily separated from the Si-containing particles 67, and conductive paths are suitably maintained.

Examples of the carbon nanotube 68 include a single-walled carbon nanotube (SWCNT) including single layer graphene, a double-walled carbon nanotube (DWCNT) including two different SWCNTs, a multi-walled carbon nanotube (MWCNT) including three or more different SWCNTs, and the like. From the viewpoint of further enhancing the capacity of the secondary battery 100, the single-walled carbon nanotube (SWCNT) is preferred.

The average length of the carbon nanotube 68 is not particularly limited, and is preferably 1 μm or more and 10 μm or less, and more preferably 1 μm or more and 5 μm or less. When having a length within the range, the carbon nanotube 68 is properly dispersed, and suitable conductive paths are formed. The average diameter of the carbon nanotube 68 is not particularly limited, and is preferably 1 nm or more and 100 nm or less, and more preferably 10 nm or more and 50 nm or less. The average length and average diameter of the carbon nanotube 68 can be each obtained, for example, by taking electron micrographs of carbon nanotubes, measuring the length and diameter of 30 or more carbon nanotubes, and obtaining the average values thereof.

Because the Si-containing particles 67 have the pores 67b and the weight ratio of the Si-containing particles 67 and the carbon nanotube 68 is properly adjusted, the carbon nanotube 68 is suitably placed around the Si-containing particles 67 (specifically, at least some of the pores 67b of the Si-containing particles 67). Because of this, conductive paths are suitably formed in the negative active material layer 64, and thus the initial charge-discharge efficiency is enhanced. When the weight of the Si-containing particles 67 is 100 wt %, the weight ratio X of the carbon nanotube 68 to the Si-containing particles 67 is preferably 0.02 wt % or more and 4 wt % or less, more preferably 0.2 wt % or more and 1 wt % or less, and further preferably 0.2 wt % or more and 0.6 wt % or less. In other words, in the secondary battery 100 disclosed herein, the ratio of the amount of the carbon nanotube 68 (wt %) to the amount of the Si-containing particles 67 (wt %) (CNT/Si-containing particles) is preferably 0.0002 or more and 0.04 or less, more preferably 0.002 or more and 0.01 or less, and further preferably 0.002 or more and 0.006 or less.

The amount of the carbon nanotube is not particularly limited, and is preferably 0.01 wt % or more and 1.4 wt % or less, more preferably 0.1 wt % or more and 1 wt % or less, and further preferably 0.1 wt % or more and 0.2 wt % or less when the total weight of the negative active materials is 100 wt %. That is, the negative active materials and the carbon nanotube are preferably negative active materials: CNT=100:0.01 to 100:1.4 on a weight basis, more preferably negative active materials: CNT=100:0.1 to 100:1, and further preferably negative active materials: CNT=100:0.1 to 100:0.2.

The negative active material layer 64 may include components (e.g., a binder) other than the negative active materials (the graphite particles 66 and the Si-containing particles 67) and the conductive material (the carbon nanotube). As the binder, conventionally known binders can be used. Examples of the binder include carboxymethyl cellulose (CMC), polyacrylic acid (PAA), styrene butadiene rubber (SBR), polyvinylidene difluoride (PVDF) and the like. Among these, CMC, PAA and SBR can be preferably used. In addition, CMC, PAA and SBR are preferably used in combination, but the present disclosure is not particularly limited thereto.

The total amount of the binders is, for example, 1 wt % or more, preferably 3 wt % or more, and more preferably 3.5 wt % or more when the weight of the negative active materials is 100 wt %. In addition, the total amount of the binders is 10 wt % or less, preferably 8 wt % or less, and more preferably 5 wt % or less when the weight of the negative active materials is 100 wt %.

When the Si-containing particles 67 are porous bodies having a plurality of pores, it is presumed that not only the carbon nanotube 68 but also the binder, not shown, are placed around the Si-containing particles 67. Because of this, the carbon nanotube 68 is not easily separated from the Si-containing particles 67, and the initial charge-discharge efficiency and cycle characteristics can be enhanced.

The thickness per surface of the negative active material layer 64 is not particularly limited, and is, for example, 20 μm or more, and preferably 50 μm or more. Meanwhile, the thickness is, for example, 300 μm or less, and preferably 200 μm or less.

The proportion of the negative active materials in the whole negative active material layer 64 is not particularly limited, and is, for example, 80 μmass % or more, preferably 90 mass % or more, and further preferably 95 μmass % or more. The proportion of the negative active materials in the whole negative active material layer 64 is not particularly limited, and may be, for example, 98 μmass % or less.

### <Method for Producing Secondary Battery>

As described above, the secondary battery 100 disclosed herein includes the graphite particles 66, the Si-containing particles 67 and the carbon nanotube 68, and the carbon nanotube 68 is placed in at least some of the pores of the Si-containing particles 67. Such secondary battery 100 can be produced, for example, as described below.

FIG. 4 is a flowchart showing one suitable embodiment of a method for manufacturing the secondary battery 100 disclosed herein. As shown in FIG. 4, the method for manufacturing the secondary battery 100 disclosed herein includes a preparation step S10 of preparing materials, and a mixing step S20 of mixing the prepared materials. The mixing step S20 preferably includes a first mixing step S21 of mixing Si-containing particles and a carbon nanotube to prepare a first mixture, and a second mixing step S22 of mixing the first mixture, graphite particles, a binder and a solvent to prepare a second mixture. However, the manufacturing method disclosed herein may further include other steps in optional stages.

In the preparation step S10, at least the graphite particles 66, the Si-containing particles 67 and the carbon nanotube 68 are prepared. In the preparation step S10, other necessary components (e.g., a binder and a solvent) can be also prepared. As described above, natural graphite and artificial graphite can be preferably used as the graphite particles 66. As the Si-containing particles 67, porous bodies including the Si nanoparticles 67a with a network structure are prepared. As the Si-containing particles 67, for example, a plant-derived Si—C composite and/or Si particles are preferably prepared. As the Si-containing particles 67, more preferably, a Si—C composite and/or Si particles derived from chaff are prepared. As the carbon nanotube 68, one in a water soluble paste form with a solid content percentage of about 1% to 10% is preferably prepared.

As the binder, those described above as examples can be used without particular restrictions. As the solvent, both an aqueous solvent and a nonaqueous solvent can be used. Typically, water or a mixed solvent having water as a main component is preferably used. As solvent components other than water forming the mixed solvent, one or two or more organic solvents which can be uniformly mixed with water (lower alcohol, lower ketone and the like) can be appropriately selected and used. Of the above aqueous solvents, an aqueous solvent having water at 80 μmass % or more (more preferably 90 μmass % or more, and further preferably 95 μmass % or more), for example, is preferably used. Particularly preferred examples thereof include aqueous solvents substantially formed from water.

The mixing step S20 can include the first mixing step S21 and the second mixing step S22. In the first mixing step S21, the Si-containing particles 67 and the carbon nanotube 68 are mixed to produce a first mixture. The carbon nanotube 68 can be suitably placed in some of the pores 67b of the Si-containing particles 67 by mixing the Si-containing particles 67 and the carbon nanotube 68 in advance and then mixing the obtained mixture and other materials. Because of this, conductive paths are easily formed, and the initial charge-discharge efficiency of the secondary battery 100 can be enhanced.

In the first mixing step S21, for example, powder Si-containing particles 67 and a carbon nanotube 68 paste are put in a stirring device and mixed. The stirring device is only required to have, for example, a rotating stirring bar (stirring blade such as a dispersion blade or a turbine blade, or a stirring wing), and is not particularly limited. The rotation frequency of stirring is not particularly limited, and may be, for example, about 1000 rpm to 5000 rpm.

In the second mixing step S22, the first mixture produced in the first mixing step S21, the graphite particles 66, the binder and the solvent are mixed to produce a second mixture. The stirring device is not particularly limited, and the same stirring device as in the first mixing step S21 may be used. When a powder binder is used in the second mixing step S22, powder graphite particles 66 and the binder is dry-mixed, and the first mixture and the solvent are added thereto, followed by solid kneading, but the present disclosure is not particularly limited thereto. Because of this, dispersibility can be enhanced.

The produced second mixture is applied to the negative current collector 62 and dried. It should be noted that a step of drying and pressing the negative active material layer 64 placed on the negative current collector 62 may be carried out as needed. By doing this, the thickness and density of the negative active material layer 64 can be adjusted.

The positive active material layer 54 can be formed by dispersing a positive active material, a conductive material and a binder in a proper solvent (e.g., NMP) to prepare a paste (or slurry) composition, applying the composition to the surface of the positive current collector 52, and drying the composition. After this, the thickness and the density of the positive active material layer 54 can be adjusted by pressing as needed.

The produced negative electrode 60 and positive electrode 50 are laminated so that the electrodes will be insulated by two separators 70. The prepared laminated body is wound around the winding axis in the longitudinal direction as needed, and the wound laminated body is pressed to produce a flat-shaped wound electrode body. The wound electrode body is held in the battery case 30, and a nonaqueous electrolyte solution is injected into the case from the injection hole. After this, the injection hole is sealed to tightly close the secondary battery 100. As described above, the secondary battery 100 can be produced.

The structure of the secondary battery 100 and the method for manufacturing the secondary battery 100 according to one embodiment have been described above. The secondary battery 100 includes the graphite particles 66, the Si-containing particles 67 and the carbon nanotube 68, and when the carbon nanotube 68 is placed in at least some of the pores 67b of the Si-containing particles 67, the initial charge-discharge efficiency is enhanced. Furthermore, when the carbon nanotube 68 is placed in the pores 67b, the cutting of conductive paths due to expansion and contraction by repeating charging and discharging is suitably suppressed, and the cycle characteristics of the secondary battery 100 are enhanced. The secondary battery 100 can be utilized for various uses, and can be suitably used, for example, as a power source for motors (driving power supply) mounted on vehicles such as cars and trucks. The secondary battery 100 is suitable particularly as a power source of battery electric vehicles (BEV). The secondary battery 100 can be also suitably used to construct an assembled battery.

In the secondary battery 100, a wound electrode body is exemplified as the electrode body 20, but the electrode body is not limited thereto. A laminated electrode body, for example, may be used in which a plurality of almost rectangular positive electrodes and a plurality of almost rectangular negative electrodes are alternately laminated with separators each between the electrodes.

Test examples of the present disclosure will now be described. It should be noted, however, that the present disclosure is not intended to be limited to the contents described in the following test examples.

### 1. First Test

In the first test, the type of Si-containing particles, the weight ratio of the Si-containing particles and CNT, and the mixing method were each changed, and the initial charge-discharge efficiency of a secondary battery was evaluated.

### Example 1

First, graphite particles and Si-containing particles were prepared as negative active materials. The Si-containing particles in Example 1 are plant-derived Si—C composite particles from chaff as a raw material. A single-walled carbon nanotube (SWCNT) was also prepared as a conductive material. Carboxymethyl cellulose (CMC), polyacrylic acid (PAA) and styrene butadiene rubber (SBR) were prepared as binders. These were kneaded with water as a solvent so that graphite particles: Si-containing particles: SWCNT:CMC:PAA:SBR=65:35:0.1:1:1:1.5 on a weight basis to prepare a negative active material layer-forming slurry.

Specifically, the negative active material layer-forming slurry was mixed and kneaded as follows. First, the Si-containing particles, a SWCNT paste (solid content percentage 2%), and the solvent were put in a container. These were mixed using a disper at a rotational frequency of 3000 rpm to produce a first mixture. Next, the graphite particles, CMC and PAA were dry-mixed using a stirring granulator, and to this mixed powder, the produced first mixture and the solvent were added, followed by solid kneading. The solid content percentage at the time of solid kneading was 65%. To the mixture after solid kneading, SBR and the solvent were further added, and the obtained mixture was mixed. As described above, the negative active material layer-forming slurry was prepared.

It should be noted that the solid content percentage C (%) at the time of kneading was determined as follows. Water was added to the mixed powder of the graphite particles and the Si-containing particles in the above ratio, and a moisture percentage when the torque required for mixing is maximum is considered A (%). The water amount per 100 g of the mixed powder corresponding to the moisture percentage A (%) is considered B (ml). At this time, the solid content percentage C (%) at which the maximum torque can be provided can be calculated from Formula: C (%)=100-A=(100/(100+B))×100.

The prepared negative active material layer-forming slurry was applied to both surfaces of copper foil (thickness 10 μm) in strips. The slurry on the copper foil was dried, pressed to a predetermined thickness, and then processed into predetermined dimensions to produce a negative electrode sheet.

Next, lithium nickel cobalt manganese composite oxide (NCM) as a positive active material, acetylene black (AB) as a conductive material, and PVDF as a binder were prepared. These were mixed with N-methyl pyrrolidone (NMP) as a solvent so that the weight ratio was NCM:AB:PVDF=100:1:1, to prepare a positive active material layer-forming slurry. This slurry was applied to both surfaces of aluminum foil (thickness 15 μm) in strips. The slurry on the aluminum foil was dried, pressed to a predetermined thickness, and then processed into predetermined dimensions to produce a positive electrode sheet.

The prepared negative electrode sheet and positive electrode sheet were laminated with a separator between the sheets to produce a laminated electrode body. Current collecting leads were each attached to the positive electrode plate and the negative electrode plate, and the laminated electrode body was inserted into an outer case formed from an aluminum laminate sheet. A nonaqueous electrolyte solution was injected inside the outer case, and the opening of the outer case was sealed to produce an evaluation battery in Example 1. It should be noted that a porous polyolefin sheet having a three layer structure of PP/PE/PP was used as a separator. In addition, a nonaqueous electrolyte solution obtained by mixing ethylene carbonate (EC), fluoroethylene carbonate (FEC), ethylmethyl carbonate (EMC) and dimethyl carbonate (DMC) so that the volume ratio was EC:FEC:EMC:DMC=15:5:40:40, and dissolving LiPF₆ as a supporting salt in the obtained mixed solvent at a concentration of 1 μmol/L was used.

In Table 1, the amount (wt %) of the Si-containing particles when the weight of the negative active materials is 100 wt %, the weight ratio X (wt %) of SWCNT to the Si-containing particles when the weight of the Si-containing particles is 100 wt %, and the amount (wt %) of SWCNT when the weight of the negative active materials is 100 wt % are each shown. It should be noted that the weight ratio X of SWCNT can be obtained from Formula: weight ratio X of SWCNT=((amount of SWCNT)/(amount of Si-containing particles))×100.

### Examples 2, 3, 5 and 6

Evaluation batteries in Examples 2, 3, 5 and 6 were produced in the same manner as in Example 1 except that when the weight of the Si-containing particles was 100 wt %, the weight ratio X (wt %) of SWCNT to the Si-containing particles was changed as shown in Table 1.

### Example 4

In Example 4, a step of mixing the Si-containing particles and SWCNT in advance was not carried out. That is, the Si-containing particles, the graphite particles, CMC and PAA were dry-mixed using a stirring granulator, and to the mixed powder, a SWCNT paste (solid content percentage 2%) and the solvent were added, followed by solid kneading. The solid content percentage at the time of solid kneading was 65%. To the mixture after solid kneading, SBR and the solvent were further added, and the obtained mixture was mixed. As described above, a negative active material layer-forming slurry was prepared. An evaluation battery in Example 4 was produced in the same manner as in Example 1 except for the above.

### Example 7

Si—C composite particles produced by a CVD method were prepared as the Si-containing particles. An evaluation battery in Example 7 was produced in the same manner as in Example 1 except for the above.

### Evaluation of Initial Charge-Discharge Efficiency

In the first cycle of CCCV charge (at a rate of 0.05 C to 4.2 V and then 0.05 C cut off) and then CC discharge (at a rate of 0.05 C, 2.5 V cut off) under a 25° C. environment, the initial charge capacity and the initial discharge capacity were measured. The initial charge-discharge efficiency was obtained from the following Formula (1). The results are shown in Table 1.

$$Initial charge - discharge efficiency ( \% ) = ( ( initial discharge capacity ) / ( initial charge capacity ) ) \times 100 \qquad Formula ( 1 )$$

TABLE 1

| | | Amount of Si- | Weight ratio | Amount of | | Initial charge- |
|---|---|---|---|---|---|---|
| | Type of | containing | X of SWCNT | SWCNT | | discharge |
| | Si-containing particles | particles (wt %) | (wt %) | (wt %) | Kneading method | efficiency (%) |
| Example 1 | Plant-derived Si/C composite | 35 | 0.29 | 0.1 | First mixing −> Second | 88 |
| | particles | | | | mixing | |
| Example 2 | Plant-derived Si/C composite | 35 | 0.43 | 0.15 | First mixing −> Second | 86 |
| | particles | | | | mixing | |
| Example 3 | Plant-derived Si/C composite | 35 | 0.57 | 0.2 | First mixing −> Second | 87 |
| | particles | | | | mixing | |
| Example 4 | Plant-derived Si/C composite | 35 | 0.29 | 0.1 | Mixing simultaneously | 82 |
| | particles | | | | | |
| Example 5 | Plant-derived Si/C composite | 35 | 0.01 | 0.005 | First mixing −> Second | 77 |
| | particles | | | | mixing | |
| Example 6 | Plant-derived Si/C composite | 35 | 4.29 | 1.5 | First mixing −> Second | 73 |
| | particles | | | | mixing | |
| Example 7 | Si/C composite particles by | 35 | 0.29 | 0.1 | First mixing −> Second | 76 |
| | CVD method | | | | mixing | |

As shown in Table 1, it is found that the initial charge-discharge efficiency is 82% or more in the evaluation batteries in Examples 1 to 4. From these results, when graphite particles and Si-containing particles, which are porous bodies containing Si nanoparticles with a network structure, are included as the negative active materials, the weight ratio X of the carbon nanotube to the Si-containing particles is 0.02 wt % or more and 4 wt % or less when the weight of the Si-containing particles is 100 wt %, and CNT is placed in at least several holes of the porous bodies, a secondary battery having an excellent initial charge-discharge efficiency is achieved.

When Examples 1 to 3 in Table 1 are compared to Example 4, it is found that CNT is easily placed in the holes of the porous bodies by carrying out the second mixing step after the first mixing step of mixing the Si-containing particles and SWCNT in advance, and the initial charge-discharge efficiency is further enhanced.

### 2. Second Test

In the second test, the weight ratio of the Si-containing particles and CNT, and the pore size distribution ratio of the porous bodies were each changed, and the cycle characteristics of a secondary battery was evaluated.

### Example 11

An evaluation battery in Example 11 was produced in the same manner as in Example 1 except that the pore size distribution ratio (V₁₀/V₁₀₀) of the porous bodies of the Si-containing particles was 1.5.

### Examples 12 to 15

As the Si-containing particles, those in which the pore size distribution ratios (V₁₀/V₁₀₀) of the porous bodies are values shown in Table 2 were each prepared. When the weight of the Si-containing particles was 100 wt %, the weight ratio X of the carbon nanotube to the Si-containing particles was changed as shown in Table 2. Evaluation batteries in Examples 12 to 15 were produced in the same manner as in Example 1 except for the above.

### Calculation of Pore Size Distribution Ratio

The pore size distribution ratio was calculated based on BJH method using a specific surface area and pore size distribution analyzer (ASAP 2020 μmanufactured by Micromeritics Instrument Corporation). First, the Si-containing particles were heated and dried under vacuum to obtain a measurement sample. Next, the adsorption isotherm of the measurement sample was obtained using liquid nitrogen as a refrigerant and nitrogen gas (N₂ gas) as adsorption gas. The obtained adsorption isotherm was analyzed by BJH method to obtain log differential pore volume distribution. From the log differential pore volume distribution, the log differential pore volume V₁₀₀ of pores with a diameter of 100 nm and the log differential pore volume V₁₀ of pores with a diameter of 10 nm were obtained, and the ratio of V₁₀ to V₁₀₀ (V₁₀/V₁₀₀) was obtained. The results are shown in Table 2.

### Evaluation of Cycle Capacity Retention Rate

As one cycle of CCCV charge (at a rate of 0.4 C to 4.2 V and then 0.1 C cut off) and then CC discharge (at a rate of 0.4 C, 2.5 V cut off) under a 25° C. environment, the cycle test was carried out by repeating charging and discharging 250 cycles. The discharge capacity at the first cycle (initial capacity), and the discharge capacity at the 250th cycle were measured, and the cycle capacity retention rate was obtained from the following Formula (2). It can be said that as the cycle capacity retention rate increases, the cycle characteristics of a secondary battery increases. The results are shown in Table 2.

$$Cycle capacity retention rate ( \% ) = ( ( discharge capacity at 250 th cycle ) \text{} / ( discharge capacity at first cycle ) ) \times 100. \qquad Formula ( 2 )$$

TABLE 2

| | | Amount of Si- | Weight ratio | Amount of | | Capacity |
|---|---|---|---|---|---|---|
| | Type of | containing | X of SWCNT | SWCNT | | retention |
| | Si-containing particles | particles (wt %) | (wt %) | (wt %) | V₁₀/V₁₀₀ | rate (%) |
| Example 11 | Plant-derived Si/C composite | 35 | 0.29 | 0.1 | 1.5 | 88 |
| | particles | | | | | |
| Example 12 | Plant-derived Si/C composite | 35 | 0.43 | 0.15 | 1.2 | 86 |
| | particles | | | | | |
| Example 13 | Plant-derived Si/C composite | 35 | 0.43 | 0.15 | 0.3 | 79 |
| | particles | | | | | |
| Example 14 | Plant-derived Si/C composite | 35 | 0.01 | 0.005 | 1.3 | 77 |
| | particles | | | | | |
| Example 15 | Plant-derived Si/C composite | 35 | 0.01 | 0.005 | 0.5 | 72 |
| | particles | | | | | |

As shown in Table 2, it is found that the capacity retention rate is 79% or more in the evaluation batteries in Examples 11 to 13. From these results, when graphite particles, and Si-containing particles, which are porous bodies containing Si nanoparticles with a network structure, are included as the negative active materials, the weight ratio X of a carbon nanotube to the Si-containing particles is 0.02 wt % or more and 4 wt % or less when the weight of the Si-containing particles is 100 wt %, and CNT is placed in at least several holes of the porous bodies, the cycle characteristics of a secondary battery can be enhanced.

When Example 11 and 12 in Table 2 are compared to Example 13, it is found that when the pore size distribution ratio (V₁₀/V₁₀₀) of the porous bodies is 1 or more, the capacity retention rate is 86% or more. That is, when the pore size distribution ratio (V₁₀/V₁₀₀) of the porous bodies is 1 or more, the cycle characteristics of a secondary battery can be further enhanced.

As described above, some embodiments of the present disclosure have been described; however, the embodiments are only examples. The present disclosure can be implemented in other various forms. The present disclosure can be implemented based on the contents disclosed in the specification and technical knowledge in the art. Various variants and modifications of the embodiments shown above as examples are encompassed in the techniques described in claims. For example, part of the embodiments can be also replaced with another variant aspect, and another variant aspect can be also added to the embodiments. When technical features are not described as essential, they can be properly removed.

As described above, as specific aspects of the techniques disclosed herein, those described in the following items are provided.

Item 1: A secondary battery, including an electrode body having a positive electrode and a negative electrode, wherein the negative electrode includes a negative current collector, and a negative active material layer placed on the negative current collector, the negative active material layer includes graphite particles and Si-containing particles as negative active materials, and a carbon nanotube as a conductive material, the Si-containing particles are porous bodies containing Si nanoparticles with a network structure, the carbon nanotube is placed in at least several pores of the porous bodies, and the weight ratio X of the carbon nanotube to the Si-containing particles is 0.02 wt % or more and 4 wt % or less when the weight of the Si-containing particles is 100 wt %.

Item 2: The secondary battery according to Item 1, wherein the Si-containing particles are derived from a plant.

Item 3: The secondary battery according to Item 1 or 2, wherein the Si-containing particles have pores with a diameter of 100 nm or more and pores with a diameter of 10 nm or less, and when the log differential pore volume of the pores with a diameter of 100 nm is V₁₀₀ and the log differential pore volume of the pores with a diameter of 10 nm is V₁₀, the ratio of V₁₀ to V₁₀₀ (V₁₀/V₁₀₀) is 1 or more.

Item 4: The secondary battery according to any one of Items 1 to 3, wherein the Si nanoparticles have an average particle diameter of 50 nm or less.

Item 5: The secondary battery according to any one of Items 1 to 4, wherein the Si-containing particles are Si—C composite compounds including the Si nanoparticles with a network structure and porous carbon particles, and/or Si particles including the Si nanoparticles with a network structure and porous Si particles.

Item 6: The secondary battery according to any one of Items 1 to 5, wherein the Si-containing particles have an oxygen amount of 10 wt % or less.

Item 7: The secondary battery according to any one of Items 1 to 6, wherein when the total weight of the negative active materials is 100 wt %, the amount of the Si-containing particles is 10 wt % or more and 60 wt % or less.

Item 8: A method for manufacturing a secondary battery, including
a preparation step of preparing at least graphite particles and Si-containing particles as negative active materials and a carbon nanotube as a conductive material,
a first mixing step of preparing a first mixture by mixing the prepared Si-containing particles and carbon nanotube, and a second mixing step of preparing a second mixture by mixing the first mixture, the graphite particles, a binder and a solvent, wherein the Si-containing particles prepared in the preparation step are porous bodies containing Si nanoparticles with a network structure.

Item 9: The manufacturing method according to Item 8, wherein when the weight of the Si-containing particles is 100 wt %, the weight ratio X of the carbon nanotube to the Si-containing particles is 0.02 wt % or more and 4 wt % or less in the first mixing step.

Item 10: The manufacturing method according to Item 8 or 9, wherein when the weight of the negative active materials is 100 wt %, the amount of the graphite particles is 40 wt % or more and 90 wt % or less in the second mixing step.

What is claimed is:

1. A secondary battery, comprising an electrode body having a positive electrode and a negative electrode,
wherein the negative electrode comprises a negative current collector, and a negative active material layer placed on the negative current collector,
the negative active material layer comprises graphite particles and Si-containing particles as negative active materials, and a carbon nanotube as a conductive material,
the Si-containing particles are porous bodies containing Si nanoparticles with a network structure,
the carbon nanotube is placed in at least several pores of the porous bodies, and
a weight ratio X of the carbon nanotube to the Si-containing particles is 0.02 wt % or more and 4 wt % or less when a weight of the Si-containing particles is 100 wt %.

2. The secondary battery according to claim 1, wherein the Si-containing particles are derived from a plant.

3. The secondary battery according to claim 1,
wherein the Si-containing particles have pores with a diameter of 100 nm or more and pores with a diameter of 10 nm or less, and
when a log differential pore volume of the pores with a diameter of 100 nm is V₁₀₀ and a log differential pore volume of the pores with a diameter of 10 nm is V₁₀, a ratio of V₁₀ to V₁₀₀ (V₁₀/V₁₀₀) is 1 or more.

4. The secondary battery according to claim 1, wherein the Si nanoparticles have an average particle diameter of 50 nm or less.

5. The secondary battery according to claim 1, wherein the Si-containing particles are Si—C composite compounds comprising the Si nanoparticles with a network structure and porous carbon particles, and/or Si particles comprising the Si nanoparticles with a network structure and porous Si particles.

6. The secondary battery according to claim 1, wherein the Si-containing particles have an oxygen amount of 10 wt % or less.

7. The secondary battery according to claim 1, wherein when a total weight of the negative active materials is 100 wt %, an amount of the Si-containing particles is 10 wt % or more and 60 wt % or less.

8. A method for manufacturing a secondary battery, comprising
a preparation step of preparing at least graphite particles and Si-containing particles as negative active materials and a carbon nanotube as a conductive material,
a first mixing step of preparing a first mixture by mixing the prepared Si-containing particles and carbon nanotube, and
a second mixing step of preparing a second mixture by mixing the first mixture, the graphite particles, a binder and a solvent,
wherein the Si-containing particles prepared in the preparation step are porous bodies containing Si nanoparticles with a network structure.

9. The manufacturing method according to claim 8, wherein when a weight of the Si-containing particles is 100 wt %, a weight ratio X of the carbon nanotube to the Si-containing particles is 0.02 wt % or more and 4 wt % or less in the first mixing step.

10. The manufacturing method according to claim 8, wherein when a weight of the negative active materials is 100 wt %, an amount of the graphite particles is 40 wt % or more and 90 wt % or less in the second mixing step.
